(19) United States
(12) Patent Application Publication
(10) Pub. No.: US 2002/0109986 A1
(43) Pub. Date: Aug. 15, 2002

(54) Compliant flexible connector

(76) Inventor: Martin J. Siegel, Los Angeles, CA (US)

Correspondence Address: Gary M. Anderson, Suite 1550, 200 Oceangate, Long Beach, CA, 90802, US

(21) Appl. No.: 09/782,373

(22) Filed: Feb. 12, 2001

(51) Int. Cl. H01B 7/06; F21V 7/04

(52) U.S. Cl. 362/202; 174/69; 362/554; 362/390

(57) ABSTRACT

A Compliant flexible connector for connecting together two members. The flexible connector is an elongate metal rod or wire made of a material having a relatively low melting point. The metal rod is capable of deforming to a desired shape such that it does not work harden as a result of the deformation. Because the flexible connector does not work harden, the connector will not fracture after successive plastic deformations. The flexible connector is made of sufficient stiffness so that the connector will maintain the desired shape after it is deformed. To achieve a desired stiffness the connector can be made of varying diameters or a plurality of connectors may be bundled together. The flexible connector may be formed of an electrically conductive material to form an electrical connection between two electrical components. The flexible connector may also be formed of hollow rods to permit passage of gas and fluids. A fiber optic core may also be disposed within the hollow rods.

### BACKGROUND OF THE INVENTION

1. Field of the Invention

The present invention is directed to a flexible connector, and more particularly a flexible connector which is capable of plasticly deforming without work hardening and able to retain a desired shape after deformation.

2. Description of the Prior Art

There is nothing new about flexingly connecting two members to one another. Such a connection can be easily obtained by tying a rope or other flexible material to each component. This type of connection is also found in many electrical connections where two electrical components are electrically connected to one another by a flexible electrical cord. However, it is advantageous to have the two members flexingly connected to one another wherein the connector remains semi-rigid and thereby retaining a desired shape and maintaining the two members in a particular distal relationship. Such connections have been made by connecting two members by a series of ball and socket portions or other elaborate tubing structures to achieve a flexible connection which is rigid enough to retain a desired shape. One such type of ball and socket connector is disclosed in U.S. Pat. No. 1,276,117. However, the drawbacks of these type of connections are that they are expensive and are relatively complicated to assemble.

U.S. Pat. No. 5,461,200 discloses a stiffener for a long flexible member and is incorporated herein by reference. U.S. Pat. No. '200 discloses the use of a conformable soft iron or steel wire embedded in a flexible member in order to retain a shape to facilitate the coiling of the flexible member. The use of a conformable soft iron or steel may be adequate in facilitate the relatively mild deformations experienced when coiling a flexible member for storage. However, if the steel wire is successively deformed plasticly, or deformed greatly it will eventually work harden in the bent areas, increase in brittleness and eventually break. Additionally, U.S. Pat. No. '200 does not disclose the use of the soft steel wire as a connection, but merely as an element to assist the shape retention of the flexible connecting cable.

### SUMMARY OF THE INVENTION

It is an object of the invention to provide a compliant flexible connector to connect two members together such that the flexible connector is capable of retaining a desired shape and not suffer the effects of work hardening failure after successive deformations.

The flexible connector of the claimed invention comprises an elongate metal rod or wire made of a metal with a relatively low melting point. The use of such a metal with a low melting point results in a connector which does not work harden when deformed plasticly. Therefore, the connector can endure successive plastic deformations without the risk of experiencing failure. In order to achieve the desired stiffness the metal rod or wire is simply designed to have a particular diameter. The larger the diameter, the stiffer the connector. Alternately a plurality of metal rods or wires may be bundled together to form the connection between the two components. The stiffness of the connector may be increased by simply using a larger number of rods bundled together.

This type of connection affords the ability of using a simple metal wire or rod which is able to be deformed to a desired shape, retain that shape once deformed, and not endure the risk of a failure after successive deformations.

The flexible connector may also be made of an electrical conductive material such that an electrical connection is made between the two components An insulator or corrugated sheath may be provided over one or more metal rods to provide a plurality of insulated electrical connections.

The flexible connector may also be made of a bundle of hollow rods which permit the passage of fluids and gasses. A pressure source or vacuum may be placed at one end of the hollow rod to effectuate the passage of material through the rod. These hollow rods may also have a fiber optic core.

These and other objects, advantages and features of the claimed invention will become apparent after studying the detailed description of the preferred embodiment

### BRIEF DESCRIPTION OF THE DRAWINGS

FIG. 1 is a section view of the flexible connector of the claimed invention including a covering sheath.

FIG. 2 is a sectional view of a flexible connector of an alternate embodiment showing a bundle of flexible rods.

FIG. 3 is a sectional view of flexible connector of an alternate embodiment showing a metal rod having a larger diameter embedded within an insulating jacket.

FIG. 4 is a partially exposed view of the preferred embodiment exposing the flexible connector of the claimed invention.

FIG. 5 is a sectional view of a flexible connector of an alternate embodiment showing a bundle of hollow flexible rods.

FIG. 6 is a sectional view of a flexible connector of an alternate embodiment showing a bundle of flexible rods with a fiber optic core.

### DETAILED DESCRIPTION OF PREFERRED EMBODIMENT

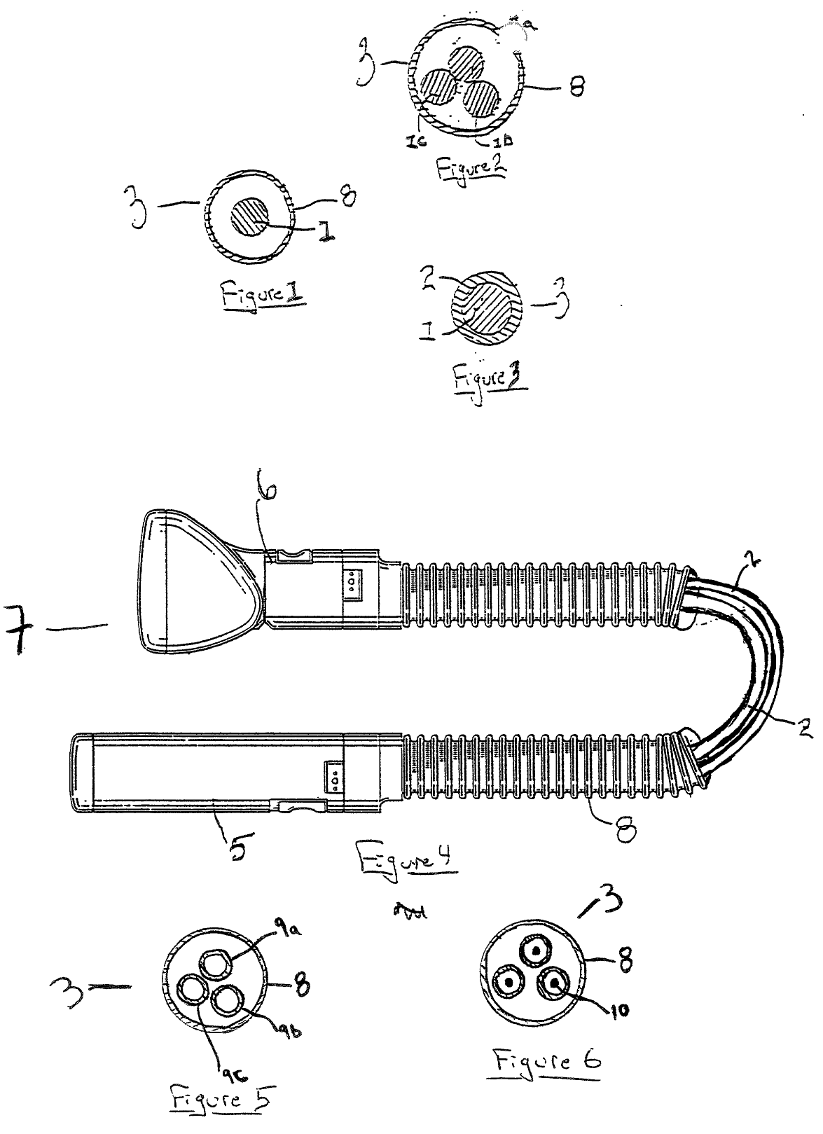

Referring now to FIG. 1, a cross section of the flexible connector 3 , reveals a metal rod or wire 1 surrounded by an covering sheath 8. In the pref erred embodiment the f lexible connector is used to connect together a headlight portion of a flashlight 6 to a battery pack 5. (See FIG. 4)

The metal wire or rod 1 is made of a metal or alloy having a low melting point, the melting temperature being below or not exceeding 850° F. The necessity of the metal having a low melting point is that when such metals are plasticly deformed they recrystallize and anneal at room temperature or below. As a result the metal does not work harden when plasticly deformed. If a metal does not work harden it will not suffer the effect of failure after numerous successive plastic deformations. Examples of such materials which would provide a good flexible connection and do not work harden are: lead; lead/tin alloys; lead/tin/zinc alloys; tin/copper alloys; tin/antimony alloys; tin/bismuth alloys; or tin/silver alloys; and precious metal alloys such as gold silver and platinum. However, the flexible connection of the claimed invention is not limited to these alloys. Any metal or alloy which has a low melting point which is capable of plastic deformation without work hardening can be substituted for the aforementioned alloys.

In order for the flexible connector to be able to retain a desired shape once deformed, it must have sufficient stiffness. The stiffness of the metal rod 1 may be varied by varying the diameter of the metal rod 1. When the diameter of the metal rod 1, is increased, the stiffness increases and thereby increases the ability of the connector to retain a desired shape. FIG. 3 represents a flexible connector 3 with a metal rod 1 of increased diameter. By choosing various low melting point metals and alloys, and varying the diameter of the metal rod 1, the ease at which the flexible connector 3 is deformed and the ability of the connector to retain a desired shape can be specifically tailored.

Another way in which to vary the relative stiffness of the flexible connector 3 is to bundle two or more metal rods parallel to one another. By increasing the number of metal rods bundled, the relative stiffness, and consequently the relative ability to retain a desired shape increases. FIG. 2 represents an embodiment wherein three metal rods 1a, 1b, 1c, are bundled within a covering sheath 8. The stiffness of the flexible connector depicted in FIG. 3 is greater than the stiffness of the flexible connector depicted in FIG. 1. By choosing a particular alloy, and varying the number of metal rods bundled, a desired stiffness can be achieved. Any number of metal rods may be utilized. By choosing a particular material, a metal rod of a certain diameter, and a specific number of bundled rods, a customized flexible connector with particular ability to deform and retain a desired shape may be obtained.

In addition to providing a flexible connection between two members, the connector of the claimed invention can also provide an electrical connection between two electrical components. By choosing a material which, in addition to having the proper low melting point and deformation characteristics, has good electrical conductive characteristics, an electrical connection can be achieved between at least two components. Two or more metal rods 1, may each be embedded within an insulating jacket 2. (See FIG. 3) The insulating jacket thereby insulates each conductive metal rod from one another. Alternately, two or more metal rods may be embedded within a single insulating jacket providing an electrical resistance therebetween. Therefore, a flexible connector may have two metal rods, one providing a positive voltage source to a component, and the other providing the necessary ground to that component. The insulating jacket 2 may be formed of any material as conventionally found in the art.

Such combined use of a flexible and electrical connector is utilized in the flexible connection of portion of a flexible flashlight such as the Grip Liter™. In the embodiment depicted in FIG. 4, it is desirable for a person to grasp the battery pack 5 and the headlight portion 6 of a flashlight 7, and be able to wrap the connector about some foreign object. Once the flexible connector is wrapped around the foreign object and deformed to a particular shape, the metal rod 1 should be able to retain the deformed shape so as to allow the flashlight 7 to remain attached to the foreign object. It is also desirable for the flexible connector 3 to be able to provide the necessary electrical contact between the battery pack 5 and the headlight portion 6.

In this preferred embodiment, connector 3 is provided with two ⅛″ diameter metal rods made of a tin/antimony alloy. The two metal rods are embedded within an insulator jacket 2 and electrically insulated from one another. Alternately each metal rod 1 may be embedded within a single insulating jacket and electrically insulated from one another. The two rods provide a positive and negative electrical contact between the battery pack 5 and the headlight portion 6. The choice of two ⅛″ diameter tin/antimony metal rods has been shown to provide a connector which is easily deformed by a human of even limited physical abilities and capable of retaining a deformed shape to allow the flashlight to grasp onto and remain attached to a foreign object. It has also been shown to enable the headlight portion to be aimed in a particular direction, and once so positioned, able to maintain the aim of the projected light in a fixed position. A covering sheath 8 is simply provided over the flexible connector to retard the entrance of foreign material between where the metal rods are connected to the battery pack 5 and headlight portion 6. The sheath 8 also serves an aesthetic function as well.

The connection between the metal rods and the component to which it is attached can be made in a number of ways. For example the metal rod may be simply wrapped around a projection portion of each component to be connected. The metal rod 1 may also be soldered to an electrical contact in each of the two components. Soldering the metal rod 1 to a metal portion of the component facilitates a good metal electrical contact between each of the components.

FIG. 5 represents an alternate embodiment of the claimed invention wherein a bundle of hollow rods 9a, 9b, 9c are disposed within the covering sheath 8. The bundle of hollow rods are capable of being successively deformed while allowing the passage of fluids, gas, or the like. This embodiment finds numerous useful applications. One of the hollow rods 9a can provide a source of water, while another hollow rod 9b can provide a suction source. In another embodiment, one hollow rod can provide a source of oxygen while a second hollow rod provides a source of acetylene. Such an embodiment would find usefulness in the welding art.

FIG. 6 represents yet another embodiment of the claimed invention. A fibre optic core 10 may be disposed within the hollow rods. Such an embodiment would find usefulness where a light source must be precisely aimed and the position must be maintained in a hands free environment. Such an application would find particular usefulness in the are of medical surgery where a light source is required to illuminate a specific are. Additionally, the fibre optic cables could be used to transmit digital signals.

While the flexible connector of this invention has been shown and described with reference to particular embodiments, it is understood to those possessing skill in the art that various changes to the form and detail may be made therein without departing from the spirit and scope of the invention.

1. A compliant flexible connector, for connecting together at least two members, said connector comprising:
at least one continuous elongate metal rod, disposed between said at least two members forming a connection therebetween;
wherein said at least one metal rod is capable of deforming to a desired shape which when deformed does not work harden, said rod having sufficient stiffness to maintain said desired shape once deformed and thereby maintaining said at least two members in a variable predetermined geometric relationship.

2. A compliant flexible connector as recited in claim 1, wherein said at least one metal rod includes a bundle of at least two metal rods connected between said at least two members in substantial parallel relationship, said flexible connector further comprising;
an insulating jacket disposed about said bundle of at least two metal rods to insulate said metal rods form the environment.

3. A compliant flexible connector as recited in claim 1, wherein said at least one metal rod includes a bundle of at least two metal rods connected between said at least two members in substantial parallel relationship, said flexible connector further comprising;
at least two insulating jackets one each disposed about each of said at least two metal rods to insulate said metal rods form the environment.

4. A compliant flexible connector as recited in claim 3, wherein said at least two metal rods are formed of an electrically conductive material to form an electrical connection between said at least two members, said at least two insulating jackets providing an electrical insulation between each of said at least two metal rods.

5. A compliant flexible connector as recited in claim 2, wherein said flexible connector further comprises;
a sheath loosely disposed about said insulating jacket and extending from one of said at least two members to a second member to isolate said insulating jacket from the environment.

6. A compliant flexible connector as recited in claim 1, wherein said metal rod is designed of a specific diameter to provide a specific stiffness and shape retention ability.

7. A compliant flexible connector as recited in claim 1, wherein said at least one metal rod comprises a plurality of bundled metal rods, said bundle is designed with a specific number of metal rods to provide a specific stiffness and shape retention ability.

8. A compliant flexible connector as recited in claim 1, wherein said flexible connector further comprises;
a sheath loosely disposed about said at least one continuous elongate metal rod and extending from one of said at least two members to a second member to isolate said at least one metal rod from the environment.

9. A compliant flexible connector, for connecting together at least two components, said connector comprising:
an insulating jacket;
at least one continuous elongate metal rod disposed within said jacket and disposed between said at least two components forming a connection therebetween;
wherein said metal rod has a melting point below 850° F. and is capable of deforming to a desired shape which when deformed does not work harden, said rod having sufficient stiffness to maintain said desired shape once deformed.

10. A flexible connector according to claim 9, wherein said at least two components comprise separate components of a flashlight, said flashlight comprising;
a headlight portion; and
a battery pack portion;
wherein said at least one metal rod comprises two metal rods made of an electrical conductive material each electrically insulated from one another, said flexible connection forming a flexible electrical contact between said headlight portion and said battery pack portion so that said flexible connector maintains a desired shaped to maintain said battery pack and said headlight portion in a particular distal relationship.

11. A compliant flexible connector as recited in claim 1, wherein said at least one metal rod is made of a hollow rod.

12. A compliant flexible connector as recited in claim 11, wherein said flexible connector further comprises:
a fibre optic core disposed within said hollow rod.

13. A compliant flexible as recited in claim 7, wherein said plurality of bundled metal rods is comprised of a plurality of bundled hollow metal rods.

14. A compliant flexible connector as recited in claim 13, further comprising:
a plurality of fibre optic cores disposed within each of said hollow metal rods.
